(19) United States
(12) Patent Application Publication
(10) Pub. No.: US 2006/0113835 A1
(43) Pub. Date: Jun. 1, 2006

(54) Electronically regulated vehicle brake system

(76) Inventors: Frank Krueger, Hohnstein (DE); Andreas Weh, Sulzberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/282,689

(22) Filed: Nov. 21, 2005

(30) Foreign Application Priority Data
Nov. 24, 2004 (DE) 10 2004 056 661.5

(51) Int. Cl. B60T 8/36

(52) U.S. Cl. 303/119.2

(57) ABSTRACT

An electronically regulatable vehicle brake system, in which a master cylinder cooperates with a hydraulic unit having electronically triggerable valves for modulating the brake pressure of the system. A triggerable, externally driven pressure generator is provided for this purpose; its intake side can be made to communicate with the master cylinder via an intake line controllable by an intake valve unit. For this purpose, an electronically triggerable magnet valve and a mechanical blocking valve are connected in parallel. The blocking valve has a blocking valve member, which when a pressure threshold in the master cylinder is exceeded can be moved out of an open basic position into a blocking position counter to the force of a compression spring. As the electromagnet valve of the intake valve unit, a valve that is structurally identical to one of the valves for modulating the brake pressure can be used.

### CROSS-REFERENCE TO RELATED APPLICATIONS

This application is based on German Patent Application 10 2004 056 661.5 filed Nov. 24, 2004, upon which priority is claimed.

### BACKGROUND OF THE INVENTION

1. Field of the Invention

In modern motor vehicles, electronically regulatable vehicle brake systems are used not only for their actual braking function but also for preventing unstable vehicle travel states. Unstable travel states go hand in hand with the occurrence of wheel slip at least one of the vehicle wheels. Wheel slip can be eliminated by targeted braking of the affected vehicle wheel. In the anti-lock braking mode, blocking of one of the vehicle wheels during a braking event is therefore prevented by modulating the brake pressure, while in the traction control mode, spinning of a driven vehicle wheel is avoided by braking the affected wheel, and in the vehicle stability control mode, skidding of the vehicle is counteracted by purposeful brake engagement. In all these cases, an electronic control unit, with the aid of sensors, serves to detect the braking or travel status of the vehicle and to evaluate the arriving signals as appropriate trigger signals for the components of the vehicle brake system.

2. Description of the Prior Art

Various models of electronically regulatable vehicle brake systems are being manufactured. A distinction is made between conventional systems, in which the brake pressure is generated by the driver by muscle force, and so-called electrohydraulic systems, in which the brake pressure is furnished by external force, by an externally driven pressure generator. Regardless of how the brake pressure is furnished, regulating the brake pressure is done by electronic triggering of electromagnet valves and pressure generators, which are combined into a compact structural unit in a so-called hydraulic unit.

An electronically regulatable vehicle brake system of a conventional, muscle-force-operated design is already known, for instance from German patent disclosure DE 41 38 027 A1. This vehicle brake system has a master cylinder in which a brake pressure is built up by the driver by muscle force. The master cylinder is hydraulically coupled with a hydraulic unit. In the hydraulic unit, among other elements there are electronically triggerable magnet valves, for modulating the brake pressure at a wheel brake. The hydraulic unit furthermore has a triggerable pressure generator. By its intake side, it is connected downstream of the valves for modulating the brake pressure into a hydraulic circuit. Its compression side discharges back into the hydraulic circuit upstream of these valves for modulating the brake pressure. An additional intake line connects the intake side of the pressure generator to the master cylinder. This line connection is controlled by a mechanical blocking valve. The blocking valve operates without a valve spring and prevents a flow of pressure fluid from the intake side of the pressure generator back to the master cylinder, and it opens as soon as an underpressure is present at the intake line. An electromagnet valve connected parallel to the blocking valve controls a pressure fluid communication from the master cylinder to the wheel brakes of a brake circuit. If it is electronically triggered, the electromagnet valve interrupts this pressure fluid communication and thus hydraulically disconnects the master cylinder from the wheel brakes. This is the case in the anti-lock mode, for instance, during which the brake pressure is modulated solely by the pressure generator in cooperation with the magnet valves in the wheel brakes. The pressure generator can aspirate pressure fluid as needed from the master cylinder via the opened blocking valve.

A further electronically regulatable vehicle brake system is known from German patent disclosure DE 197 01 070 A1 which pertains to a so-called electrohydraulic vehicle brake system, in which in the operational state the brake pressure is furnished solely by external force. To that end, there is a motor-driven pressure generator, which communicates via an intake line with a pressure fluid reservoir connected to a master cylinder. The intake line is controlled by a triggerable proportional valve. In this vehicle brake system, the master cylinder serves only to generate a set-point braking valve, which is specified by the driver's actuation of the brake pedal.

A parameter that is definitive for a vehicle brake system defines the dynamics with which the vehicle brake system is capable of reacting to suddenly changing braking conditions. For high dynamics, relatively large control cross sections of the valve devices are advantageous, especially in the case of a valve device for controlling the intake line of the pressure generator. For low ambient temperatures, relatively large control cross sections are also favorable, since in that case, because of the low viscosity of the pressure fluid, the speed with which an increase in the brake pressure in the vehicle brake system occurs necessarily drops. There are technical limits to an arbitrary increase in size of the control cross sections of the valves, because of the associated dimensioning of the magnetic circuit of the valve and the resultant structural size of the valve. In practice, besides valves with suitably large control cross sections, precontrollable hydraulic valves have also proved themselves, among others. These valve models, however, are special models that must be developed specifically for this purpose, and they are therefore disadvantageous because so many parts are needed and because of the handling, design and maintenance costs to the manufacturer of such vehicle brake systems.

### OBJECTS AND SUMMARY OF THE INVENTION

By comparison, a vehicle brake system of the invention has the advantage that with relatively little engineering effort and expense, an increased pressure fluid throughput in the intake line of the pressure generator is attained, even at low ambient temperatures. Valves developed specifically for controlling the intake line are no longer necessary, since now a valve structurally identical to the valve for modulating the brake pressure can be used in the intake valve unit. This reduces the number of parts needed and lessens the requisite effort and expense in assembling, developing, and maintaining such vehicle brake systems.

The invention comprises using a 2/2-way magnet valve connected parallel to a mechanical blocking valve, whose blocking valve member, if a pressure threshold in the master cylinder is exceeded, can be moved out of its open basic position into its blocking position counter to the force of a restoring element.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a hydraulic circuit diagram of a vehicle brake system in which the brake pressure in the normal braking mode is generated by muscle force, with an intake valve unit according to the invention;

FIG. 2 is a highly simplified and schematically showing of a mechanical blocking valve of the intake valve unit of the invention in a first variant embodiment as a ball seat valve;

FIG. 3 shows the blocking valve in a second variant embodiment as a plate valve;

FIG. 4 shows the blocking valve in a third variant embodiment as a slide valve, the blocking valves each being shown in FIGS. 2-4 hydraulically actuated by the absolute pressure in the master cylinder; and

FIG. 5 shows the blocking valve in a fourth variant embodiment, in which its hydraulic actuation is effected by the pressure difference between the absolute pressure in the master cylinder and the atmospheric pressure in the environment.

### DESCRIPTION OF THE PREFERRED EMBODIMENTS

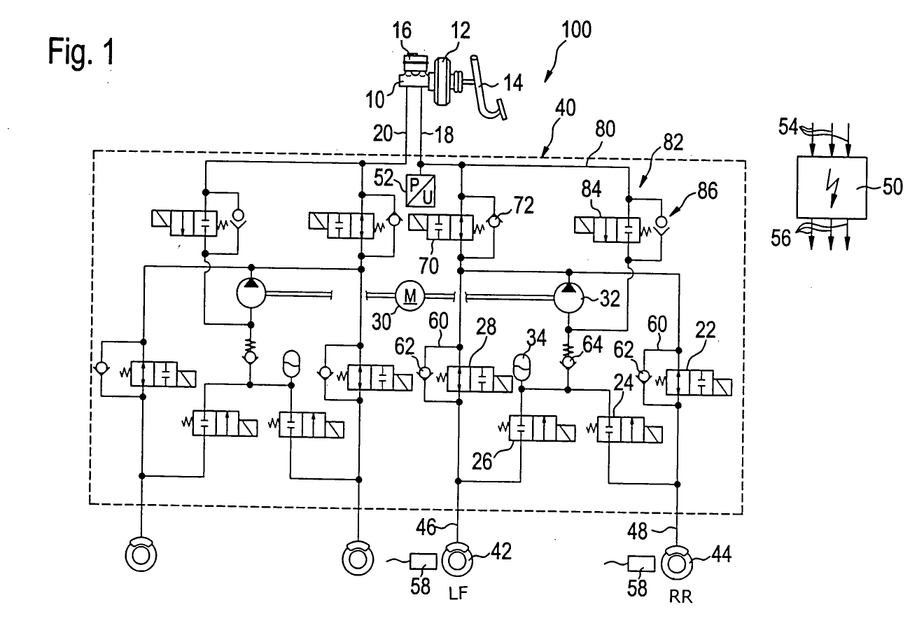

The vehicle brake system 100 shown in FIG. 1 includes a master cylinder 10, which is actuatable by the driver by muscle force via a brake booster 12 and a pedal 14 operatively connected to the brake booster. The master cylinder 10 is supplied with pressure fluid via a pressure fluid reservoir 16. Two brake circuits 18, 20 that are separate from one another are connected to the master cylinder 10. The two brake circuits 18, 20 are constructed symmetrically, and the ensuing description will therefore be limited essentially to brake circuit 18.

For modulating the brake pressure in the brake circuit 18, magnet valves 22-28, a pressure generator or pump 32 driven by an external motor 30, and a low-pressure reservoir 34 are connected to one another in a hydraulic circuit. These components 22-28, 30, 32 are disposed in a common hydraulic unit, identified by reference numeral 40, which is represented schematically in FIG. 1 by a broken line. Two wheel brakes 42, 44 of the vehicle are connected to this hydraulic unit 40 via brake lines 46, 48. The wheel brakes 42, 44 are identified as LF (left front) and RR (right rear), in accordance with their location in the vehicle. The brake circuits of the vehicle brake system 100 are accordingly distributed diagonally.

An electronic control unit 50 detects input variables 54 measured by sensors 52, 58 and processes them into trigger signals 56 for the magnet valves 22-28 and the motor 30 of the pressure generator 32. The control unit 50 adapts the brake pressure to the slip conditions ascertained at the various vehicle wheels. To that end, a pressure sensor 52 detects the brake pressure prevailing in the master cylinder 10, which represents a set-point value specified by the driver via the pedal 14. Via rpm sensors 58 at the vehicle wheels, the control unit 50 ascertains any danger of wheel locking that might exist. There may also be other sensors, not shown, for instance for detecting the actuation travel or actuation speed of the bake pedal 14, or pressure sensors at various points of the hydraulic circuit, for making additional input variables available to the control unit 50 for the sake of improving the capability of regulating the vehicle brake system 100.

There is one brake pressure buildup valve 22, 28 hydraulically upstream and one brake pressure reduction valve 24, 26 hydraulically downstream of each vehicle wheel. The valves 22-28 are represented by hydraulic switching symbols. Thus these valves 22-28 are electromagnetically actuatable 2/2-way switchover valves, which are kept in their basic position by a restoring device. The pressure buildup valves are open in the basic position, while the pressure reduction valves are blocked in the basic position. A check valve 62 is connected parallel to the pressure buildup valves 22 and 28 in a bypass 60. This check valve opens in the direction from the wheel brake 42, 44 to the master cylinder 10 and thereby makes a fast pressure reduction possible when the brake pressure at the master cylinder 10 is decreasing, or in other words when the driver expresses a wish to lessen the braking.

The pressure generator 32 is connected downstream of the pressure reduction valves 24, 26 and feeds pressure fluid from the wheel brakes 42, 44 back into the hydraulic circuit. In a low-pressure reservoir 34 connected between the wheel brake 42, 44 and the pressure generator 32, pressure fluid can be stored temporarily, so as to assure the supply of pressure fluid to the pressure generator 32 upon startup of the pressure generator. A check valve 64 opening in the direction upstream of the pressure generator 32 prevents pressure fluid from flowing from the pressure generator back into the wheel brake 42, 44.

Besides the aforementioned magnet valves 22-28 for modulating the brake pressure, the brake circuit 18 of the vehicle brake system 100 also has a so-called switchover valve 70. It switches the vehicle brake system 100 over from a muscle-force-actuated normal braking mode to an external-force-actuated traction control mode or a vehicle stability control mode. This switchover valve 70 is a 2/2-way switching valve that can be switched electromagnetically out of its open position into a blocking position, counter to the force of a restoring device. In the blocked state, the communication of the master cylinder 10 with the wheel brakes 42, 44 is interrupted. A muscle-force-actuated brake pressure buildup is not possible then; in other words, in that case a brake pressure buildup is effected solely by means of the external-force-driven pressure generator 32.

A check valve 72 is also connected parallel the switchover valve 70. This check valve blocks in the direction of the master cylinder 10 and opens in the direction of the wheel brake 42, 44. When there is a high pressure upstream of the switchover valve 70, pressure fluid can thus flow into the downstream part of the hydraulic circuit. This situation occurs for instance whenever the driver actuates the brake pedal 14 during a fully active brake pressure regulating operation, for instance during a traction control mode, and the brake pressure thus generated in the master cylinder 10 is higher than the pressure downstream of the switchover valve 70.

An intake line 80 leads from the master cylinder 10 to the intake side of the pressure generator 32, and as a result, the pressure generator can feed pressure fluid as needed to the wheel brakes 42, 44 from the reservoir 16 that is coupled to the master cylinder 10. For controlling this intake line 80, a valve unit 82 is provided according to the invention; it comprises a triggerable electromagnet valve 84 and a mechanical blocking valve 86 connected parallel to the electromagnet valve. The blocking valve 86 has a blocking valve member 88 for controlling a control cross section 92 between an inflow connection 94 and an outflow connection 96. In the pressureless state of the vehicle brake system 100 as shown, the blocking valve member 88 is in its open basic position, while the electromagnet valve 84 is in its blocking position, as long as no electronic triggering by the control unit 50 is taking place.

The electromagnet valve 84 of the valve unit 82 is a 2/2-way valve that can open counter to the force of a restoring element. It is advantageously embodied structurally identically to the pressure reduction valves 24, 26, which reduces the number of different valve models in the vehicle brake system 100 and thus lessens the technical complexity of the vehicle brake system.

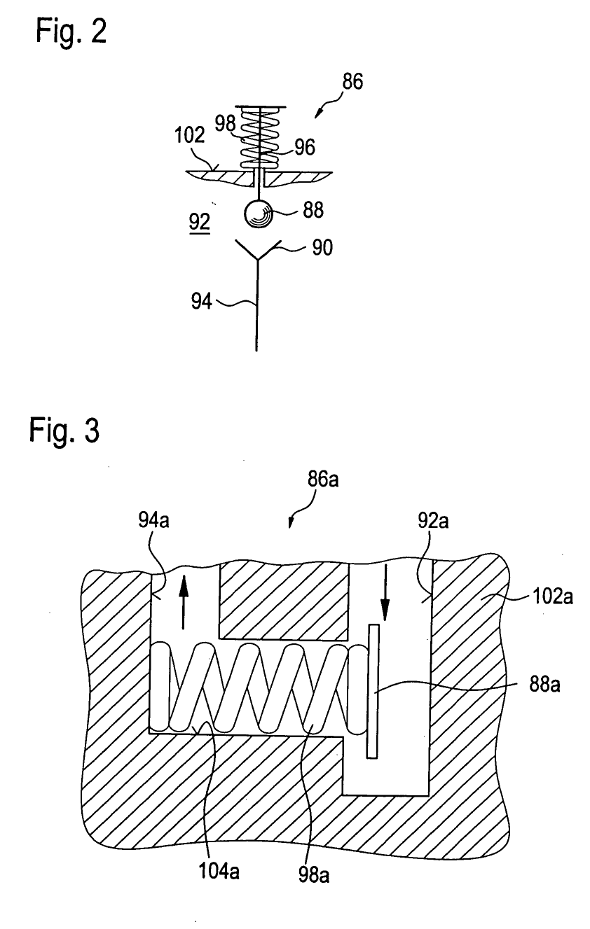

Structurally, various valve models are conceivable for the blocking valve 86. A first exemplary embodiment is shown, schematically and highly simplified, in FIG. 2. In this exemplary embodiment, a ball that cooperates with a conical valve seat 90 is used as the blocking valve member 88. The conical valve seat 90 is located between an inflow connection 92 and an outflow connection 94; the inflow connection 92 is connected to the master cylinder 10, and the outflow connection 94 is connected to the intake side of the pressure generator 32. The blocking valve member 88 is secured to one end of a tappet 96. The end of the tappet 96 diametrically opposite the ball is engaged by a prestressed compression spring 98. This spring is braced by its second end on a shoulder, located between the ends of the tappet 98, of a blocking valve housing 102 shown only in fragmentary form. In the pressureless state, as shown, the compression spring 98 keeps the blocking valve 86 in the open position, and as a result there is a pressure fluid communication from the inflow connection 92 to the outflow connection 94. In this position, the external-force-driven pressure generator 32 of FIG. 1 can aspirate pressure fluid from the master cylinder 10 and, with the pressure buildup valves 22, 28 open and the pressure reduction valves 24, 26 closed, can bring about a fully active pressure buildup in the wheel brakes 42, 44. If the driver should actuate the pedal 14 during such a fully active pressure buildup, the pressure in the master cylinder 10 rises, and because of the hydraulic pressure force engaging it the blocking valve member 88 is deflected in the direction of the conical valve seat 90 counter to the force of the compression spring 98. Once a pressure level in the master cylinder 10 that is dependent on the prestressing of the compression spring 98 is reached, the blocking valve member 88 closes the conical valve seat 90 completely and thus interrupts the pressure fluid communication between the inflow connection 92 and the outflow connection 94, or in other words from the master cylinder 10 to the intake side of the pressure generator 32.

Instead of a ball valve, a plate or flat-seat valve can be used as the blocking valve 86, as shown in simplified form in FIG. 3. The mechanical switching valve 86a shown has a flat-seat valve housing 102a with an inflow connection 92a toward the master cylinder and an outflow connection 94a toward the pump intake side. Both connections 92a, 94a are located parallel and side by side and communicate with one another through a transverse conduit 104a. In the transverse conduit 104a, there is a compression spring 98a, which is braced, on the outflow end of this transverse conduit 104a, on the wall of the flat-seat valve housing 102a and which on its diametrically opposite end has a plane valve plate, as its blocking valve member 88a. The length of the compression spring 98a is adapted to the length of the transverse conduit 104a such that in the pressureless state, the valve plate is spaced apart from the mouth of the transverse conduit 104a into the cross section of the inflow connection 92a toward the master cylinder. There is accordingly a pressure fluid communication from the inflow connection 92a to the outflow connection 94a of the blocking valve 86a, and as a result the pressure generator 32 is capable of performing a fully active pressure buildup with pressure fluid from the master cylinder 10 into the wheel brakes 42, 44. With increasing pressure in the master cylinder 10 because of an actuation of the pedal 14 by the driver, the valve plate moves in the direction of the cross section of the mouth of the transverse conduit 104a into the inflow connection 92a and closes this inflow connection, as soon as the pressure level in the master cylinder 10 has exceeded a limit value that is determined by the design of the compression spring 98a.

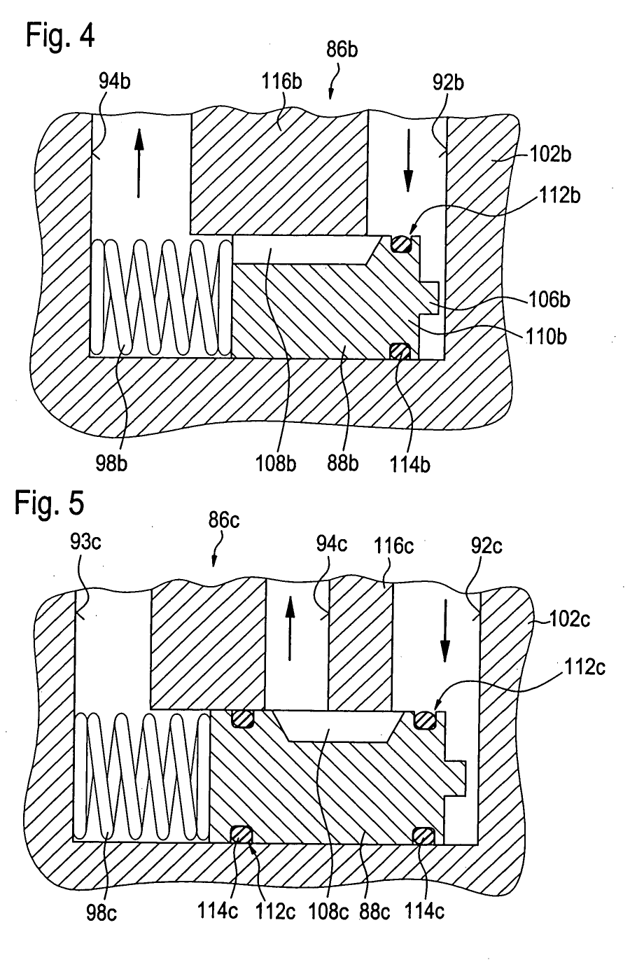

As shown in FIG. 4, the blocking valve may also be embodied as a slide valve 86b. In a slide valve 86b, the blocking valve member is formed by a valve slide 88b. The valve slide 88b is pistonlike and on its inflow end it has a centrally disposed, axially protruding stop 106b. This stop keeps the valve slide 88b spaced apart from the wall of the valve housing 102b, in order to enable a hydraulic actuation of the valve slide 88b with the pressure in the inflow connection 92b. The valve slide 88b is provided with at least one longitudinal groove 108b along its circumference. The longitudinal groove 108b begins at the outflow end of the valve slide 88b and extends over part of the entire axial length of the valve slide. The length of the longitudinal groove is dependent on the axial spacing between the inflow connection 92b and an outflow connection 94b on the valve housing 102b. The longitudinal groove 108b is adjoined by an end portion 10b of the valve slide 88b that is free of longitudinal grooves. A sealing ring 114b is located in an encompassing annular groove 112b of this end portion 10b. In the basic position of the slide valve 86b as shown, this sealing ring 114b is out of engagement with the valve housing 102b, and there is therefore a pressure fluid communication from the inflow connection 92b to the outflow connection 194b via the longitudinal groove 108b. An increasing pressure at the inflow connection 92b causes a motion of the slide, counter to the force of a compression spring 98b that is located on the outflow side and is braced between the valve housing 102b and the valve slide 88b, until the sealing ring 114b finally meets a partition 116b between the inflow connection 92b and the outflow connection 94b and thus blocks the pressure fluid communication.

In a further variant of a slide valve 86c shown in FIG. 5, the valve housing 102c has a total of three connections. A first connection again communicates with the master cylinder 10 and forms the inflow connection 92c of the slide valve 86c; a second connection communicates with the intake side of the pressure generator 32 and forms the outflow connection 94c; and a third connection 93c communicates with the ambient atmosphere. The third connection 93c discharges into the installation space for a compression spring 98c that acts on the valve slide 88c and ventilates this space. The valve slide 88c itself is still pistonlike. It has a recess 108c on its circumference whose axial length is greater than the spacing between the inflow connection 92c and the outflow connection 94c. In the basic position of this slide valve 86c, there is a pressure fluid communication between the inflow connection 92c and the outflow connection 94c via this recess 108c. On both sides of the recess 108c, sealing rings 114c are located in annular grooves 112c. The sealing ring 114c on the outflow side divides the installation space of the compression spring 98c from the recess 108c, while the sealing ring 114c on the inflow side blocks the communication from the inflow connection 92c to the outflow connection 94c, as soon as the valve slide 88b, because of the pressure in the inflow connection 92c, is put counter to the force of the compression spring 98c into a position in which this sealing ring 114c enters into interaction with a partition 116c between the inflow connection 92c and the outflow connection 94c. Because of the ventilation of the installation space of the compression spring 98c to the atmosphere, in this exemplary embodiment the valve slide 88c is controlled by the pressure difference between the absolute pressure in the master cylinder 10 and the ambient atmospheric pressure, while in the exemplary embodiments described earlier above, the valve closing members 88a, 88b, 88c are acted upon by the pressure difference between the pressure at the respective inflow connection 92a, 92b, 92c and the respective outflow connection 94a, 94b, 94c.

As explained above, the mechanical blocking valve 86 is located in a bypass around the electromagnet valve 84 and, up to a certain pressure level in the master cylinder that is dictated by the design of the electromagnet valve, assumes an open position. The blocking valve 86 together with the electromagnet valve 84 thus makes an intake path with especially low flow resistance available to the pressure generator 32, and this allows easy aspiration of pressure fluid from the master cylinder. This goes hand in hand with an increase in pressure buildup dynamics during a fully active pressure buildup of the vehicle brake system 100, as is necessary during the traction control mode or the vehicle stability control mode. In both of these operating modes, even at low ambient temperatures, when the pressure fluid is correspondingly more viscous, pressure fluid in sufficient quantity can be made available to the pressure generator 32 by the valve unit 82 of the invention, and relatively good pressure buildup dynamics can be attained. If the driver actuates the pedal 14 during a fully active pressure buildup, then the pressure buildup in the master cylinder 10 brings about the closing motion of the blocking valve member 86. Together with a lessening of the electronic triggering of the electromagnet valve 84, in these operating modes an unwanted aspiration of pressure fluid from the master cylinder 10 by the external-force-driven pressure generator 32 is then no longer possible.

It is understood that changes and additions to the exemplary embodiments described can be made without departing from the fundamental concept of the invention. In this respect it should be noted once again that the invention is not limited to the muscle-force-actuated vehicle brake system 100 shown in the exemplary embodiment, but instead can be used in vehicle brake systems with an external-force-actuated service brake. In such vehicle brake systems, the master cylinder can be hydraulically decoupled from the brake circuit by disconnection valves and serves solely to detect the driver's wishes in terms of braking. If the external force supply fails, the disconnection valves open and make muscle-force-actuated auxiliary braking possible.

The foregoing relates to preferred exemplary embodiments of the invention, it being understood that other variants and embodiments thereof are possible within the spirit and scope of the invention, the latter being defined by the appended claims.

We claim:

1. In an electronically regulatable vehicle brake system, having a master cylinder and a hydraulic unit connected to the master cylinder, which has electronically triggerable valves for modulating the bake pressure at at least one wheel brake and a triggerable, externally driven hydraulic pressure generator, which can be made to communicate with the master cylinder via an intake line that is controllable by an intake valve unit, the improvement wherein the intake valve unit comprises a triggerable electromagnet valve and a mechanical blocking valve which is connected parallel to the electromagnet valve and which can be moved from its open basic position into its blocking position counter to the force of a restoring element if a pressure threshold in the master cylinder is exceeded.

2. The electronically regulatable vehicle brake system in accordance with claim 1, wherein the valves for modulating the brake pressure include a 2/2-way switchover valve that blocks in its basic position, and wherein the electromagnet valve of the intake valve unit is embodied structurally identically to this switchover valve.

3. The electronically regulatable vehicle brake system in accordance with claim 1, wherein the blocking valve of the intake valve unit comprises a ball or a valve slide as its blocking valve member, which counter to the force of a restoring element controls a control cross section between an inflow connection and an outflow connection of the blocking valve.

4. The electronically regulatable vehicle brake system in accordance with claim 2, wherein the blocking valve of the intake valve unit comprises a ball or a valve slide as its blocking valve member, which counter to the force of a restoring element controls a control cross section between an inflow connection and an outflow connection of the blocking valve.

5. The electronically regulatable vehicle brake system in accordance with claim 1, wherein the blocking valve member is urged in the opening direction by a prestressed compression spring.

6. The electronically regulatable vehicle brake system in accordance with claim 2, wherein the blocking valve member is urged in the opening direction by a prestressed compression spring.

7. The electronically regulatable vehicle brake system in accordance with claim 3, wherein the blocking valve member is urged in the opening direction by a prestressed compression spring.

8. The electronically regulatable vehicle brake system in accordance with claim 1, wherein the blocking valve member is hydraulically subjected to pressure by the absolute pressure at the master cylinder, or by the pressure difference between the absolute pressure at the master cylinder and the ambient atmospheric pressure.

9. The electronically regulatable vehicle brake system in accordance with claim 2, wherein the blocking valve member is hydraulically subjected to pressure by the absolute pressure at the master cylinder, or by the pressure difference between the absolute pressure at the master cylinder and the ambient atmospheric pressure.

10. The electronically regulatable vehicle brake system in accordance with claim 3, wherein the blocking valve member is hydraulically subjected to pressure by the absolute pressure at the master cylinder, or by the pressure difference between the absolute pressure at the master cylinder and the ambient atmospheric pressure.

11. The electronically regulatable vehicle brake system in accordance with claim 5, wherein the blocking valve member is hydraulically subjected to pressure by the absolute pressure at the master cylinder, or by the pressure difference between the absolute pressure at the master cylinder and the ambient atmospheric pressure.

12. The electronically regulatable vehicle brake system in accordance with claim 1, wherein the pressure generator is connected downstream of the valves for modulating the brake pressure by its intake side into a hydraulic circuit and by its compression side to a point of the hydraulic circuit that is located between a valve device, for controlling a communication of the master cylinder with the wheel brake, and the valves for modulating the brake pressure.

13. The electronically regulatable vehicle brake system in accordance with claim 2, wherein the pressure generator is connected downstream of the valves for modulating the brake pressure by its intake side into a hydraulic circuit and by its compression side to a point of the hydraulic circuit that is located between a valve device, for controlling a communication of the master cylinder with the wheel brake, and the valves for modulating the brake pressure.

14. The electronically regulatable vehicle brake system in accordance with claim 3, wherein the pressure generator is connected downstream of the valves for modulating the brake pressure by its intake side into a hydraulic circuit and by its compression side to a point of the hydraulic circuit that is located between a valve device, for controlling a communication of the master cylinder with the wheel brake, and the valves for modulating the brake pressure.

15. The electronically regulatable vehicle brake system in accordance with claim 5, wherein the pressure generator is connected downstream of the valves for modulating the brake pressure by its intake side into a hydraulic circuit and by its compression side to a point of the hydraulic circuit that is located between a valve device, for controlling a communication of the master cylinder with the wheel brake, and the valves for modulating the brake pressure.

16. The electronically regulatable vehicle brake system in accordance with claim 8, wherein the pressure generator is connected downstream of the valves for modulating the brake pressure by its intake side into a hydraulic circuit and by its compression side to a point of the hydraulic circuit that is located between a valve device, for controlling a communication of the master cylinder with the wheel brake, and the valves for modulating the brake pressure.

17. The electronically regulatable vehicle brake system in accordance with claim 1, wherein the vehicle brake system comprises an external-force-actuated service brake.

18. The electronically regulatable vehicle brake system in accordance with claim 2, wherein the vehicle brake system comprises an external-force-actuated service brake.

19. The electronically regulatable vehicle brake system in accordance with claim 3, wherein the vehicle brake system comprises an external-force-actuated service brake.

20. The electronically regulatable vehicle brake system in accordance with claim 5, wherein the vehicle brake system comprises an external-force-actuated service brake.
